(19) United States
(12) Patent Application Publication
(10) Pub. No.: US 2014/0287341 A1
(43) Pub. Date: Sep. 25, 2014

(54) MODIFIED ANODE/ELECTROLYTE STRUCTURE FOR A SOLID OXIDE ELECTROCHEMICAL CELL AND A METHOD FOR MAKING SAID STRUCTURE

(71) Applicants: Mohammed Hussain Abdul Jabbar, Chennai (IN); Jens Høgh, Frederiksberg C (DK); Eugen Stamate, Roskilde (DK)

(72) Inventors: Mohammed Hussain Abdul Jabbar, Chennai (IN); Jens Høgh, Frederiksberg C (DK); Eugen Stamate, Roskilde (DK)

(73) Assignee: Technical University of Denmark, Kgs. Lyngby (DK)

(21) Appl. No.: 14/353,583

(22) PCT Filed: Oct. 23, 2012
(86) PCT No.: PCT/EP2012/070949

§ 371 Date: Apr. 23, 2014

(30) Foreign Application Priority Data
Oct. 24, 2011 (DK) PA 2011 00810

(51) Int. Cl. C25B 11/04; H01M 8/12

(52) U.S. Cl. CPC C25B 11/0426; H01M 8/124; C25B 11/041; H01M 2008/1293
USPC 429/482; 205/629; 427/77

(57) ABSTRACT

A novel modified anode/electrolyte structure for a solid oxide electrochemical cell is an assembly comprising (a) an anode consisting of a backbone of electronically conductive perovskite oxides selected from the group of doped strontium titanates and mixtures thereof, (b) a scandia and yttria-stabilised zirconium oxide electrolyte and (c) a metallic and/or a ceramic electrocatalyst in the shape of interlayers incorporated in the interface between the anode and the electrolyte. This assembly is first sintered at a given temperature and then at a lower temperature in reducing gas mixtures. These heat treatments resulted in a distribution of the metallic and/or ceramic interlayers in the electrolyte/anode backbone junction taking place. The structure is prepared by (a) depositing a ceramic interlayer onto one side of the electrolyte, (b) optionally applying a metallic interlayer thereon, (c) repeating steps (a) and (b), (d) applying a layer of the selected anode backbone onto the electrolyte with applied interlayers, (e) sintering the raw assembly and (f) infiltrating the electrocatalyst precursor into the sintered assembly and heat treating the assembly to incorporate additional electrocatalyst into the anode backbone.

### TECHNICAL FIELD

The present invention relates to a method of improving the performance of the fuel electrode in a solid oxide electrochemical cell. More specifically, the invention concerns a modified anode/electrolyte structure for a solid oxide electrochemical cell, and further the invention concerns a method for making said structure.

### BACKGROUND OF THE INVENTION

A solid oxide fuel cell (SOFC) is an electrochemical cell with an anode (fuel electrode) and a cathode separated by a dense oxide ion conductive electrolyte, said cell operating at high temperatures (800-1000° C.). The function of an anode in the solid oxide fuel cell is to react electrochemically with the fuel, which may be hydrogen and hydrocarbons, while the cathode reacts with air or oxygen to produce electric current. The anode of an SOFC comprises a catalytically active, conductive (for electrons and oxide ions) porous structure, which is deposited on the electrolyte.

The conventional SOFC anodes include a composite mixture of a metallic catalyst and a ceramic material, more specifically nickel and yttria-stabilized zirconium oxide (YSZ), respectively.

The anodes (fuel electrodes) must be capable of yielding a high performance in terms of high electrochemical activity and good redox stability to be employed in fuel cells such as SOFCs. Current state-of-the-art Ni—YSZ anodes provide a reasonable electrochemical activity at high operating temperatures, often above 800° C., but they are not redox stable. Any volume changes in Ni—YSZ anodes due to reduction and oxidation of Ni will result in inexpedient mechanical stresses in the anode material, which in turn will impair the overall performance of the fuel cell.

Over the recent years a number of efforts have been made to improve the functioning of SOFC anodes. For instance, the published US patent application No. 2009/0218311 describes the preparation of a catalyst with a layered structure in the electrode/electrolyte interface of a fuel cell. A plastic or glass substrate is used together with an electrolyte (such as YSZ), a catalyst layer (such as Ni or Pd) and a porous layer. However, the catalyst keeps its layered structure during the process, and thus it is not distributed.

US 2010/0075194 discloses a high performance, low cost cathode with low polarization resistance, which binds well to an electrolyte. This publication deals with an ion-conductive layer (doped cerium oxide) followed by a mixed ion-conductive and electron-conductive layer. Again, the catalyst remains in the layered structure and therefore does not become distributed.

US 2009/0148742 concerns high performance multilayer electrodes and i.a. mentions insertion of a cerium oxide based ion-conductive and electron-conductive layer in the interface between anode and electrolyte to improve the electrochemical performance of SOFC anodes.

In U.S. Pat. No. 6,420,064 it is described how a composite cathode containing mixed electron-conductive (Pd) and ion-conductive (YSZ) functional layers gets deposited on the electrolyte by e.g. screen printing. Then lanthanum cobaltite is printed over the functional layers, which are subsequently sintered in situ during operation of the SOFC.

US 2009/0011314 concerns an SOFC with reduced electrical resistance, which comprises an interfacial layer containing an ion-conductive material inserted between an electrode layer and an electrolyte layer. The ion-conductive material can i.a. be YSZ or GDC, preferably inserted by atomic layer deposition (ALD), and a catalytic metal, such as Pt, may be present.

Finally, US 2009/0061284 belonging to the present applicant describes that i.a. niobium-doped strontium titanate can be used as SOFC anode and impregnated with Ni and doped cerium oxide. The interface of the electrode/electrolyte was not modified in this instance, but the same niobium-doped strontium titanate as in the present invention was present.

The recent developments within high performance SOFC anodes have been focused on utilizing the redox stable electronically conductive perovskite oxides, such as niobium-doped strontium titanate (STN). While STN is stable under anode testing conditions and also compatible with the electrolyte, it lacks electrochemical catalytic activity for the hydrogen oxidation, and moreover, the ionic conductivity is insufficient for an efficient anode performance.

STN deposited on the electrolyte has a skeletal porous structure (termed “backbone” in the following), which is capable of holding the electrocatalyst. One of the recent trends within the development of anodes has been to incorporate a nanostructured electrocatalyst in the backbone by catalyst infiltration of one of the respective salts, such as nickel nitrate or nickel chloride. The electrocatalyst can be a metal, a ceramic material such as gadolinium-doped cerium oxide (CGO) or a mixture of both. In addition, CGO provides ionic conductivity in the backbone.

### DESCRIPTION OF THE INVENTION

The present invention is based on the surprising finding that the performance of the STN backbone as an SOFC anode is dramatically improved, if thin metal layers (such as Ni, Pd and combinations thereof), ceramic layers (such as CGO, YSZ and combinations thereof) or both metal and ceramic layers are introduced in the interface of the backbone/electrode assembly (BEA), whereupon the finished assembly is heated to a high temperature, possibly to distribute the metal/ceramic functional interlayers in the backbone and into the BEA. Such distributed functional interlayers act as electrochemically active electrodes, and furthermore, infiltration of the electrocatalyst into the STN backbone improves the anode performance dramatically, as already mentioned.

More specifically, the present invention concerns a novel modified anode/electrolyte structure for a solid oxide electrochemical cell, said structure being an assembly comprising (a) an anode consisting of a backbone of electronically conductive perovskite oxides selected from the group of niobium-doped strontium titanate, vanadium-doped strontium titanate, tantalum-doped strontium titanate and mixtures thereof, (b) a scandia and yttria-stabilised zirconium oxide electrolyte and (c) a metallic and/or a ceramic electrocatalyst in the shape of interlayers incorporated in the interface between the anode and the electrolyte. This assembly is first subjected to sintering at a temperature of about 1200° C. in air, and then the sintered assembly is heated to about 1000° C. for up to 5 hours in H₂/N₂ in a separate furnace. These heat treatments result in the metallic and/or ceramic interlayers being distributed in the electrolyte/anode backbone junction.

Furthermore the invention concerns a process for the preparation of the inventive anode/electrolyte structure, said process comprising the steps of (a) depositing a ceramic interlayer onto one side of the electrolyte, (b) optionally applying a metallic interlayer thereon, (c) repeating steps (a) and (b), (d) applying a layer of the selected anode backbone onto the electrolyte with applied interlayers, (e) sintering the raw assembly by heating it to about 1200° C. in air, whereafter the sintered assembly is heated to about 1000° C. for up to 5 hrs in H₂/N₂, and (f) infiltrating the electrocatalyst precursor into the sintered assembly and further heat treating the sintered assembly at a temperature of about 350-650° C. in air to incorporate the electro-catalyst into the anode backbone.

The idea of depositing a metallic layer, a ceramic layer or a combination of both in the BEA interface to locate the catalyst in the required site for the electrochemical reaction of fuel constitutes a novel approach in designing SOFC anodes. It is also novel to utilize the well-known solution infiltration technique on a modified backbone, whereby the performance of the anode is surprisingly enhanced with the increase of loadings of the electrocatalyst.

Use of the conventional solution infiltration technique to incorporate an electrocatalyst in the STN backbone does not in itself ensure that the BEA interface is sufficiently covered or coated. Thus, no further decrease in the interfacial resistance is possible, even after increasing the loadings of the electrocatalyst. On the contrary, by the present invention the electrocatalysts are located either on the BEA interface or on sites which are favourable for the improved electrochemical reaction. This way the interfacial resistance is further decreased.

The metal-based functional layer (MFL) is preferably Pd, but other metals, such as Ni, Pt and Ru, are also conceivable. Furthermore, instead of single metals it is possible to use binary alloys of the above metals, such as Pd—Ni, or even ternary alloys, such as Pd—Ni—Ru. As to the ceramic-based functional layer (CFL), this is preferably gadolinium-doped cerium oxide (CGO), but it could also be e.g. samarium-doped cerium oxide.

Using the present invention it is possible to avoid the known blending of metal (such as Ni) and ceramics (such as YSZ) to form a composite anode. Further, the solution infiltration technique to incorporate an electrocatalyst in a perovskite-based anode is supplemented.

The present invention offers a number of advantages over the prior art technique, first of all lowering the interfacial resistance by several orders of magnitude compared with conventional anodes. The invention also provides a suitable way to lower the operating temperatures of solid oxide fuel cells (<600° C.). Furthermore, the process according to the invention, where thin metal or ceramic film layers are deposited on the electrolyte surface, makes it possible to increase the production speed considerably when making solid oxide fuel cells.

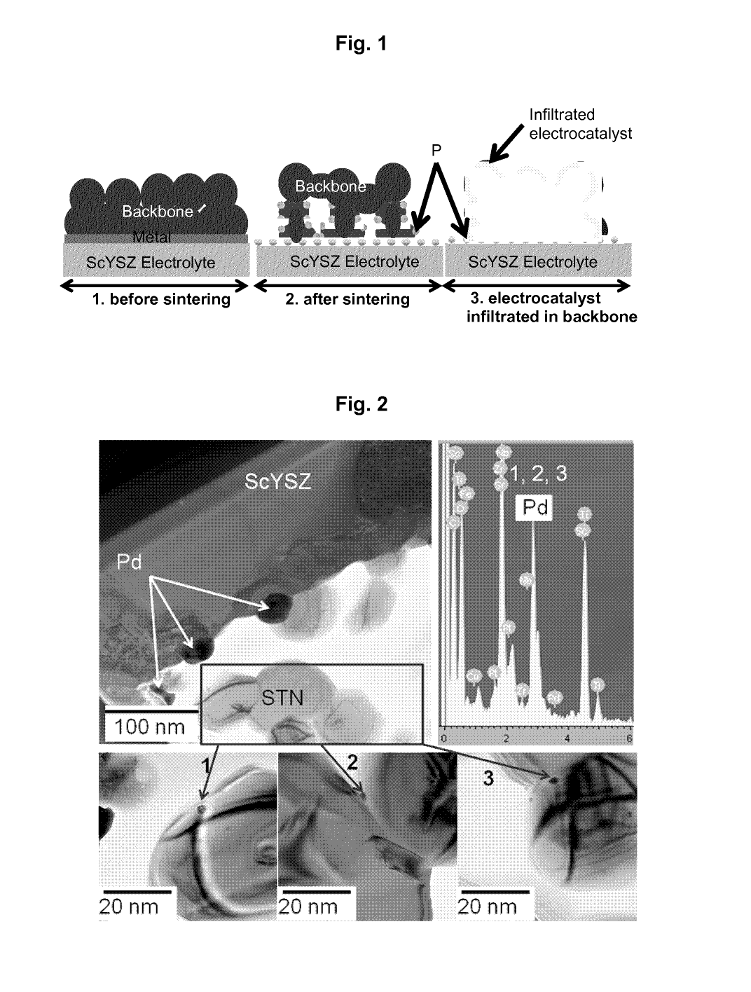

The invention will now be illustrated further by the following specific examples. Reference is also made to the accompanying FIGS. 1-6, where

FIG. 1 is a schematic outline of the process according to the invention,

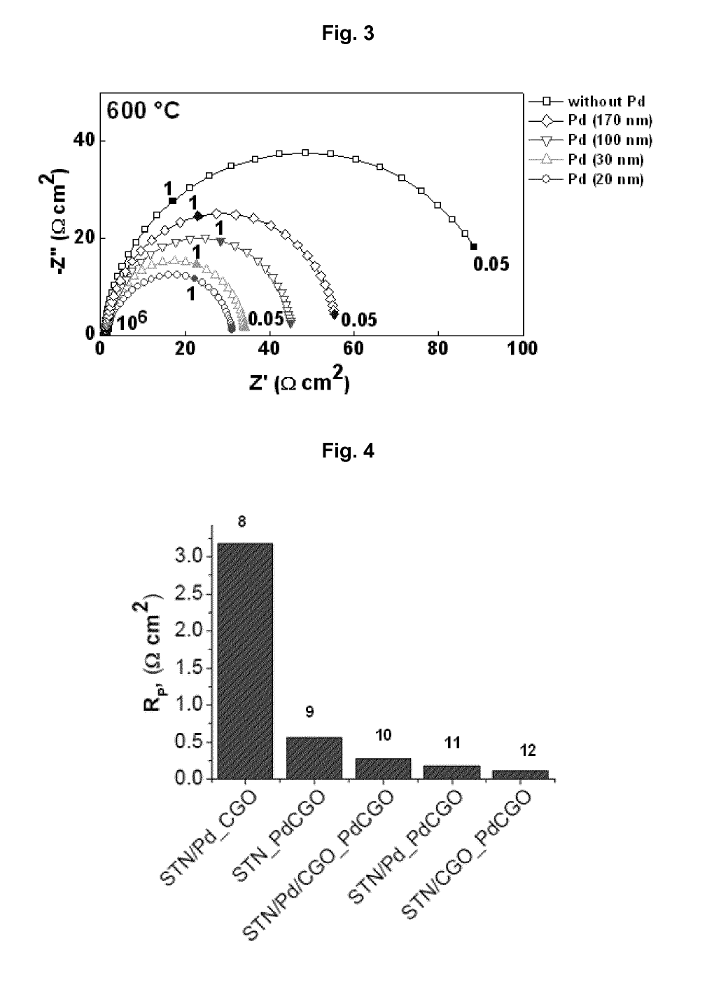

FIG. 2 shows the transmission electron microscopy (TEM) images of the sintered STN backbone with MFL on ScYSZ electrolyte,

FIG. 3 shows the impedance spectra obtained at 600° C. in 3% H₂O/H₂ fuel for various MFL thicknesses in STN/ScYSZ interfaces,

FIG. 4 shows the performance of a number of anodes prepared according to the invention at 600° C. in 3% H₂O/H₂ fuel,

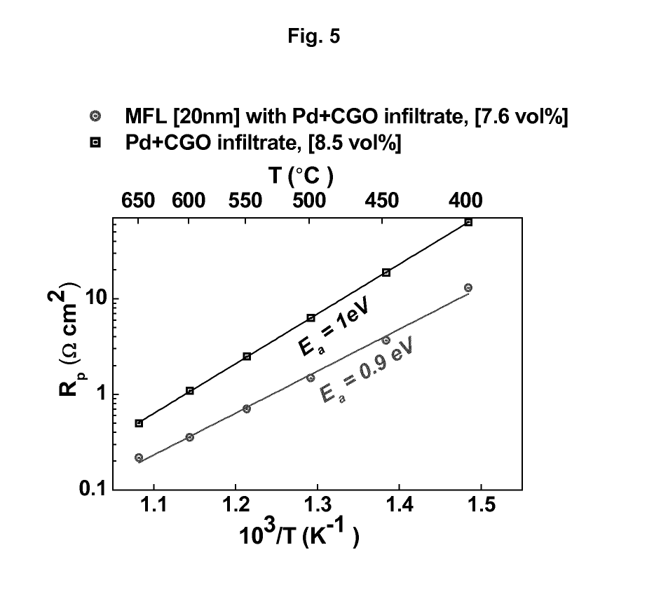

FIG. 5 is the Arrhenius plot obtained for the STN symmetrical cells with and without MFL with equal loading of Pd—CGO electrocatalysts, and

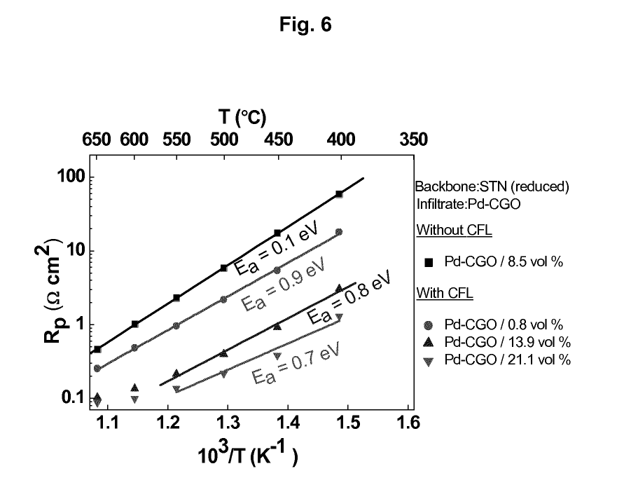

FIG. 6 is the Arrhenius plot obtained for the STN symmetrical cells with and without CFL. The loadings of Pd—CGO electrocatalysts are varied.

### EXAMPLE 1

This example illustrates the method steps involved in the production of SOFC anodes according to the invention. The example is supported by FIG. 1.

As electrolyte a tape of ScYSZ (scandia and yttria-stabilized zirconia) with a thickness of 120 μm was used. The backbone was niobium-doped strontium titanate (STN) placed upon the electrolyte to form a backbone/electrolyte assembly (BEA).

A functional layer was introduced in the BEA, i.e. between the backbone and the electrolyte. Said functional layer may be a metal-based functional layer (MFL), e.g. Pd in a layer thickness of 20-200 nm, or a ceramic-based functional layer (CFL), e.g. gadolinium-doped cerium oxide (CGO) in a layer thickness of 20-500 nm. The functional layer may also be a combination of a metal-based and a ceramic-based layer.

In practice, the functional layer is first applied to the electrolyte tape, which is done by sputtering (MFL) or spin coating (CFL). When a combined functional layer is used, the electrolyte tape is first spin coated with CGO and then sputtered with Pd. This is done on both sides of the electrolyte in case of symmetrical cells used for electrochemical electrode characterizations.

When the electrolyte has been provided with the intended functional layer(s), it is screen printed with STN ink, resulting in a layer, 18-20 μm thick, optionally on both sides of the electrolyte. The resulting “raw” assembly (FIG. 1, left part) is subsequently heated to a sintering temperature of 1200° C. for 4 hours in air or in an H₂/N₂ gas mixture. By this sintering treatment the particles (P) of the functional layer(s) are distributed over the backbone (FIG. 1, middle part).

As the final process step, the electrocatalyst is infiltrated in the form of a precursor solution into the presintered backbone (FIG. 1, right part).

### EXAMPLE 2

This example shows a few distinct Pd particles located in the interface of STN and ScYSZ electrolyte (FIG. 2, top left part) and small nanoparticles of Pd distributed over the STN backbone (FIG. 2, bottom three parts). The presence of the Pd nanoparticles in the STN backbone is confirmed using an energy dispersive spectroscopy (EDS) analysis (FIG. 2, top right part).

### EXAMPLE 3

This example presents the performance results obtained with anodes, which have been prepared as described in Example 1, but without infiltration. As reference an anode without any functional layer was used.

The tested anodes are summarized in Table 1:

TABLE 1
Composition of selected anodes

| Anode Nos. | Backbone* | Functional layer(s) |
|---|---|---|
| 1 | STN reduced | None |
| 2 | STN reduced | Pd (170 nm) |
| 3 | STN reduced | Pd (100 nm) |
| 4 | STN reduced | Pd (30 nm) |
| 5 | STN reduced | Pd (20 nm) |
| 6 | STN reduced | Pd (30 nm) + CGO |
| 7 | STN air | CGO |

*sintering conditions of the BEA are air or reduced (H₂/N₂)

The results obtained (gas conditions: 97% H₂, 3% H₂O; temperature: 600° C.) are listed in Table 2 below.

TABLE 2
Interfacial resistance of selected anodes

| | |
|---|---|
| Anode Nos. | Rₚ (Ω · cm²) |

| | | |
|---|---|---|
| 1 | (no functional layer) | 90 |
| 2 | (Pd 170 nm) | 54 |
| 3 | (Pd 100 nm) | 45 |
| 4 | (Pd 30 nm) | 33 |
| 5 | (Pd 20 nm) | 30 |
| 6 | (Pd 30 nm) + CGO | 24 |
| 7 | (CGO) | 16 |

The anode with no functional layer (anode Nos. 1) clearly shows the poorest performance, i.e. the highest interfacial resistance, of the anodes tested. The impedance spectra are shown in FIG. 3. The numbers mentioned in the spectra indicate the angular frequency.

### EXAMPLE 4

In this example the performance results obtained with five anodes, which have been prepared as described in Example 1, i.e. including infiltration, are presented.

The tested anodes are summarized in Table 3 below.

TABLE 3
Composition of selected anodes

| | | Functional | |
|---|---|---|---|
| Anode Nos. | Backbone | layer(s) | Infiltrate |
| 8 | STN reduced | Pd | CGO |
| 9 | STN reduced | None | Pd + CGO |
| 10 | STN reduced | Pd + CGO | Pd + CGO |
| 11 | STN reduced | Pd | Pd + CGO |
| 12 | STN reduced | CGO | Pd + CGO |

The results obtained (gas conditions: 97% H₂, 3% H₂O; temperature: 600° C.) are illustrated in FIG. 4.

Table 4 below is a summary of some of the favourable results obtained with anodes according to the invention compared to reference anodes with no functional layer. The first three anodes in the table are reference anodes, whereas the rest are anodes according to the invention.

TABLE 4
Interfacial resistance of selected anodes vs. reference anodes
(gas conditions: 97% H₂, 3% H₂O; temperature: 600° C.)

| | Functional | | Loading | |
|---|---|---|---|---|
| Backbone* | layer | Infiltrate | (vol. %) | Rₚ (Ω · cm²) |
| STN air | none | CGO | 10 | 4.6 |
| STN red. | none | Pd and CGO | 8.5 | 1 |
| STN air | none | Ni and CGO | 11.2 | 0.42 |
| STN red. | CGO | Pd and CGO | 0.8 | 0.25 |
| STN red. | CGO | Pd and CGO | 13.9 | 0.13 |
| STN red. | CGO | Pd and CGO | 21.1 | 0.09 |
| STN air | CGO | Ni and CGO | 8.6 | 0.19 |
| STN air | CGO | CGO | 12.8 | 2 |
| STN red. | Pd (20 nm) | Pd and CGO | 7.6 | 0.35 |
| STN red. | Pd (30 nm) | Pd and CGO | 12.2 | 0.15 |
| STN red. | Pd (100 nm) | Pd and CGO | 5 | 0.5 |
| STN red. | Pd (170 nm) | Pd and CGO | 4.2 | 0.5 |
| STN red. | Pd (30 nm) + CGO | Pd and CGO | 8.4 | 0.27 |
| STN red. | Pd (30 nm) + CGO | Ni and CGO | 11.5 | 0.23 |

*air and reduced (H₂/N₂) are the sintering conditions of the backbone/electrolyte assembly (BEA)

### EXAMPLE 5

The results shown in this example (FIG. 5) explain the improvement in performance of MFL modified STN backbone with equal loading of Pd and CGO electrocatalyst. The performance was determined in 3% H₂O/H₂ fuel.

### EXAMPLE 6

This example, shown in FIG. 6, illustrates the results obtained for the symmetrical cells with and without CFL. The results are compared with various loading of Pd and CGO electrocatalyst. It is observed that, even with a small loading (0.8% of Pd and CGO), the performance is better than the anode without CFL. The performance is greatly improved with more loading of electrocatalysts. The performance was determined in 3% H₂O/H₂ fuel.

1. A process for the preparation of a modified anode/electrolyte structure for a solid oxide electrochemical cell, said structure being an assembly comprising
(1) an anode consisting of a backbone of electronically conductive perovskite oxides selected from the group consisting of niobium-doped strontium titanate, vanadium-doped strontium titanate, tantalum-doped strontium titanate and mixtures thereof,
(2) a scandia and yttria-stabilised zirconium oxide electrolyte and
(3) a metallic and/or a ceramic electrocatalyst in the shape of interlayers incorporated in the interface between the anode and the electrolyte, characterized in that it comprises the following steps:
(a) depositing a ceramic interlayer onto one side of the electrolyte,
(b) optionally applying a metallic interlayer thereon,
(c) repeating steps (a) and (b),
(d) applying a layer of the selected anode backbone onto the electrolyte with applied interlayers,
(e) sintering the raw assembly by heating it to about 1200° C. in air, whereafter the sintered assembly is heated to about 1000° C. for up to 5 hrs in H₂/N₂, and
(f) infiltrating the electrocatalyst precursor into the sintered assembly and further heat treating the sintered assembly at a temperature of about 350-650° C. in air to incorporate the electrocatalyst into the anode backbone.

2. The process according to claim 1, characterized in that the electrolyte is a tape with a thickness of about 50-250 μm or a supported electrolyte with a thickness of about 5-50 μm.

3. The process according to claim 2, characterized in that the metallic interlayer is selected from the group consisting of Pd, Ni, Pt, Ru and combinations thereof applied in a thickness of about 20-200 nm.

4. The process according to claim 2, characterized in that the optionally applied ceramic interlayer consists of gadolinium-doped cerium oxide and un-doped cerium oxide with a thickness of about 20-500 nm.

5. The process according to claim 4, characterized in that the layer is applied by spin coating.

6. The process according to claim 1, characterized in that the metal in the electrocatalyst is selected from the group consisting of Ni, Pd, Pt, Ru and combinations thereof.

7. The process according to claim 1, characterized in that the ceramic material in the electrocatalyst is selected from the group consisting of gadolinium-doped cerium oxide, yttrium-doped cerium oxide, samarium-doped derium oxide and un-doped cerium oxide.

8. Use of an anode/electrolyte structure prepared by the process according to claim 1 in a solid oxide fuel cell (SOFC).

9. Use of an anode/electrolyte structure prepared by the process according to claim 1 in a solid oxide electrolyser cell (SOEC), in which case it is a cathode.
